(19) United States
(12) Patent Application Publication
(10) Pub. No.: US 2006/0185133 A1
(43) Pub. Date: Aug. 24, 2006

(54) Casket boxes and method OF making same

(76) Inventors: Gilles Beaulne, Blainville (CA); Normand Beauchesne, Victoriaville (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/304,749

(22) Filed: Dec. 16, 2005

Related U.S. Application Data
(60) Provisional application No. 60/654,935, filed on Feb. 23, 2005.

(51) Int. Cl. A61G 17/00

(52) U.S. Cl. 27/4

(57) ABSTRACT

A casket box having a periphery of lateral panels connected to one bottom panel at a lower edge thereof, wherein: at least one of the lateral panels has a ledge towards a top thereof, the ledge being formed by a folded portion of the lateral panel being folded along at least one successive V-groove defined in the lateral panel. A method of making a ledged lateral panel for a casket, the method comprising: providing a panel having a first side, a second side, and four edges; machining at least one V-groove parallel to a first edge of the panel; folding the panel along the at least one V-groove, into a ledge; and beveling a second and third opposed edges of the panel including the ledge.

### CROSS-REFERENCE TO RELATED APPLICATIONS

This application claims priority of U.S. provisional patent application 60/654,935, filed Feb. 23, 2005, the specification of which is hereby incorporated by reference.

### BACKGROUND OF THE INVENTION

The improvements relate to burial or cremation caskets and, more particularly, to a method for manufacturing casket boxes.

Caskets or coffins traditionally include a casket box to which is pivotally mounted a casket cover or lid. Hardwood and veneer-finished caskets represent an important market in the casket industry. Although relatives seek beautifully ornamented caskets in the memory of the deceased, their choice is limited by cost considerations. There is therefore a strong need for a choice of caskets which have an improved appearance to cost ratio.

### BRIEF SUMMARY OF THE INVENTION

It is an object of the present improvements to provide a method of producing a casket box which overcomes at least some inconveniences of the prior art.

It is an object of the present improvements to provide an ornamented casket box at a relatively low price.

One aspect of the improvements provides a casket box having a periphery of lateral panels connected to one bottom panel at a lower edge thereof, wherein: at least one of the lateral panels has a ledge towards a top thereof, the ledge being formed by a folded portion of the lateral panel being folded along at least one successive V-groove defined in the lateral panel.

Another aspect of the improvements provides a method of making a ledged lateral panel for a casket, the method comprising: providing a panel having a first side, a second side, and four edges; machining at least one V-groove parallel to a first edge of the panel; and folding the panel along the at least one V-groove, into a ledge; and beveling a second and third opposed edges of the panel including the ledge.

A further aspect of the improvements provides a casket box including a bottom panel, two opposed side panels, a front panel and a back panel, the side panels being joined to a respective edge of the front and back panels by a beveled joint, the casket box being characterized in that the front, back and side panels have a sheet of veneer on an outer side thereof, relative to the box, and are folded along V-grooves defined on the exterior of the casket box, the sheet of veneer being folded exterior the folded panels, and the sheet of veneer includes an outer layer and an inner hinge layer to facilitate its folding.

### BRIEF DESCRIPTION OF THE SEVERAL VIEWS OF THE DRAWINGS

Further features and advantages of the present improvements will become apparent from the following detailed description, taken in combination with the appended drawings, in which:

FIG. 1. is a perspective view of a casket box in accordance with one embodiment of the improvements;

FIG. 2 is a cross-sectional view of a lateral panel for a casket box, in accordance with another embodiment of the improvements, shown prior to folding;

FIG. 3 is a cross-sectional view of the lateral panel of FIG. 2, shown folded;

FIG. 4 is a cross-sectional view of an alternative to the lateral panel of FIG. 3, having only one fold;

FIG. 5 is a cross-sectional view of an alternative to the lateral panel of FIG. 2, having three V-Grooves;

FIG. 6 is a cross-sectional view of the lateral panel of FIG. 5, shown folded;

FIG. 7 is a cross-sectional view of the lateral panel of FIG. 6, shown assembled with a bottom panel along a shoulder joint;

FIG. 8 is a cross-sectional view of an alternative to the assembled lateral panel of FIG. 7, assembled along a beveled joint;

FIG. 9 is a top plan view of the lateral panel of FIG. 6, shown adjoined to another lateral panel and forming a corner of a casket box;

FIG. 10 is a flow chart illustrating steps of a method of making a lateral casket box panel in accordance with another embodiment of the improvements;

FIG. 11 is a top plan view of a foldable casket box blank in accordance with another embodiment of the improvements;

FIG. 12 is a cross-section view taken along cross-section lines 12-12 of FIG. 11; and

FIG. 13 is a cross-section view of the foldable casket box blank of FIG. 11 shown in folded configuration, forming a casket box.

It will be noted that throughout the appended drawings, like features are identified by like reference numerals.

### DETAILED DESCRIPTION OF THE INVENTION

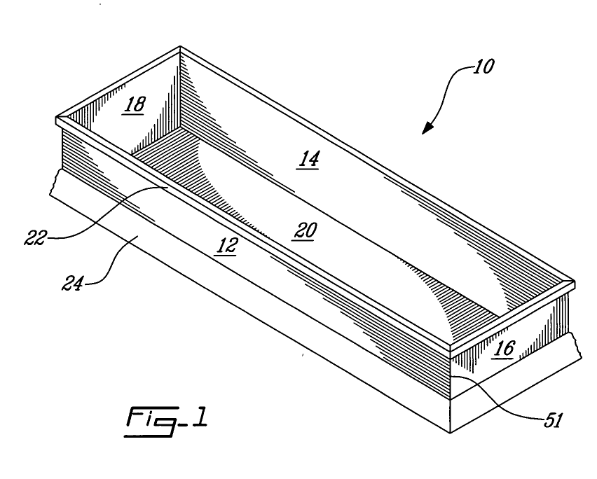

Referring now to the drawings and, more particularly to FIG. 1, one contemplates a casket box 10 having a periphery of four lateral panels: a right side panel 12, a left side panel 14, a front panel 16 and a back panel 18. The casket box 10 has an inside and an outside. In this embodiment, the lateral panels 12, 14, 16 and 18 have the same cross-section and differ only in length and orientation. Therefore, only one panel needs to be described in more detail. The right side panel 12 can be seen to include a decorative ledge 22 at its top, and a decorative molding 24 near its lower edge.

Turning to FIG. 2, a panel 12 can be seen to include two opposite sides: a first side 23 for facing the outside of the casket box 10 (FIG. 1), and a second side 25 for facing the inside the casket box 10 (FIG. 1). A first V-groove 26 and a second V-groove 28 are longitudinally defined within the first side 23 of the panel 12. In this case, the first 26 and the second 28 V-grooves are adjacent to one another, are parallel to an upper edge 29 of the lateral panel 12. The first V-groove 26 defines a first angle 31, and the second V-groove 28 defines a second angle 33. In this embodiment, both the first angle 31 and the second angle 33 are of 90°. The panel also has a lower edge 27 to be oriented towards the ground under the casket box 10 (FIG. 1). The upper edge 29 is opposite the lower edge 27. A free end 30 which is free of V-grooves extends past the second V-groove 28 on an overlap distance 32 when the panel 12 is folded along the V-grooves 26, 28 into the configuration illustrated in FIG. 3. The folded portion defines the ledge 22. The folded portion is secured into place by any suitable means, like glue and fasteners such as nails. The free end 30 then overlaps a portion of the first side 23 of the panel equivalent to the overlap distance 32. In this embodiment, the panel 12 is made of a low cost material. Solid timber, craftwood, particleboards, fiberboards, agrifiber boards, a combination of these materials or any other material adapted for the use with specific embodiments of the improvements can be used.

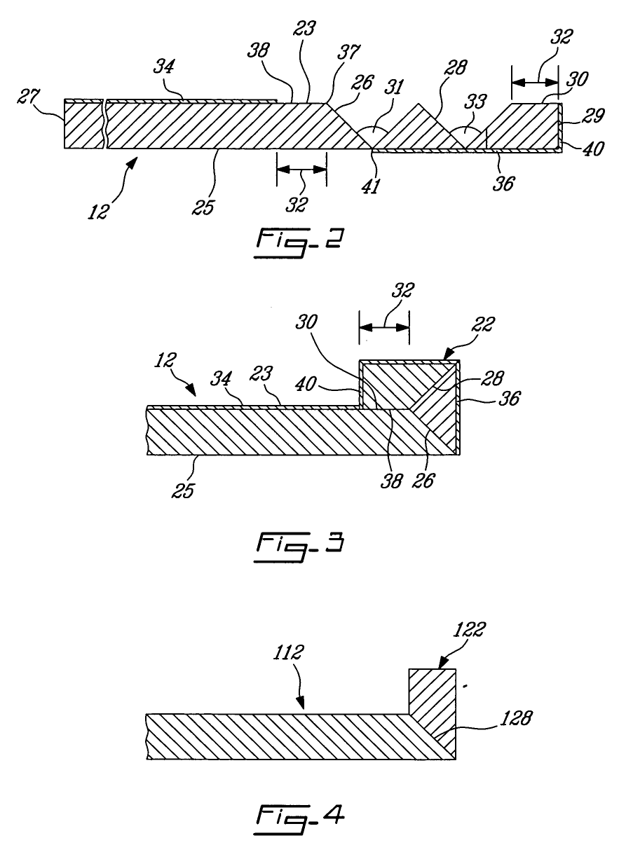

Turning back to FIG. 2, it is seen that in this embodiment, veneer such as a solid timber veneer, a wood veneer, or a plastic or paper veneer bearing a timber grain design or any other design veneer is applied to the panel 12 to enhance its external appearance. To reduce costs, only portions of the panel 12 which appear from the outside of the casket box 10 (FIG. 1) when the panel 12 is folded and assembled into a casket box 10 are veneered. A first sheet of veneer 34 is applied to a lower, unfolded portion of the first side 23 of the panel 12. In this embodiment, the first sheet of veneer 34 extends from the bottom edge 27 of the board towards the first V-groove 26, and a space of the panel 12 of a width corresponding to the overlap distance 32 is left bare of sheet of veneer between the first sheet of veneer 34 and the lower edge 37 of the first V-groove 26, to save veneer. Further veneer can be saved in the case where a molding 24 (see FIG. 1) is to be applied to the lowermost portion of the first side 23, as it will be described in more detail below, and in which case the lowermost portion is also left bare (not shown). A second sheet of veneer 36 is applied to the second side 25 of the panel 12, and extends between the upper edge 29 of the panel 12 and a fold line 41 corresponding to the center of the first V-groove 26, the V-groove which is farthest away from the upper edge 29. When the panel 12 is folded into the configuration shown in FIG. 3, the exposed portion of the first and second sides 23, 25 are covered by the sheet of veneer. In the illustrated embodiment, the upper edge 29 is covered by a third sheet of veneer 40. The third sheet of veneer 40 covers the lower side of the folded ledge 22. In this embodiment, the veneer was applied before the V-grooves 26, 28 were machined. In FIG. 4, an alternative panel 112 to the panel 12 (FIG. 3) is depicted, wherein the shoulder 122 consists of only one fold, and where there is only one V-groove 128.

In one alternative, a paper veneer layer is used in combination with a hinge layer. The hinge layer is used between the sheet of veneer and the panel 12, and reinforces the center of the V-grooves during folding. The hinge layer can be for example a layer of Kraft paper or a layer of cardboard. In one embodiment, the hinge layer pre-glued to the panel 12, and the paper veneer layer is laminated over it.

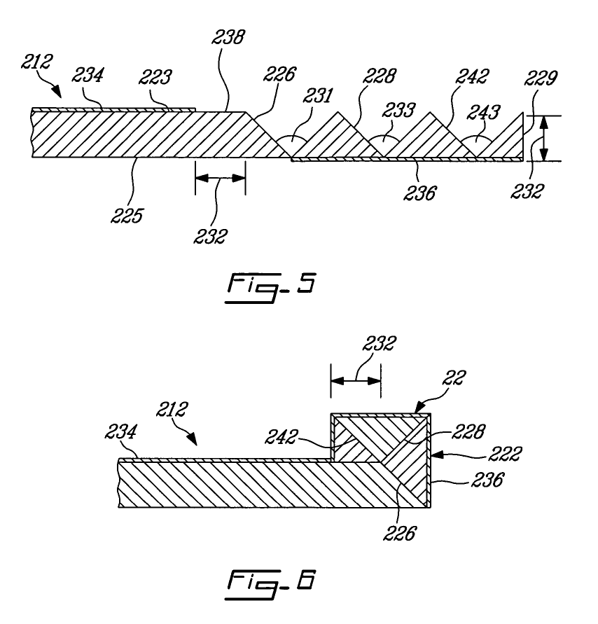

Turning now to FIG. 5, an alternative panel 212 to the panel 12 (FIG. 2) is depicted, in which similar components are numbered with similar numbers in the 200 series. In this embodiment, a first 226, a second 228, and a third 242 V-grooves are defined into the first side 223 of the panel 212. The three V-grooves 226, 228, and 242 are adjacent and parallel to one another and to the upper edge 229 of the panel 212. The V-grooves 226, 228, and 242 each define a respective angle 231, 233, and 243. A bare portion 238 having a width 232 corresponding to the thickness of the panel 212 is left bare of veneer, adjacent to the first V-groove 226, and receives the upper edge 239 of the panel 212 when the latter is folded along the three successive V-grooves 226, 228, 242 (see FIG. 6). This embodiment has the advantage with respect to the embodiment of FIGS. 2 and 3 that the upper edge 239 does not need to be veneered for the entire visible portion of the folded ledge 222 to be veneered, which saves the costs associated with veneering the upper edge 239.

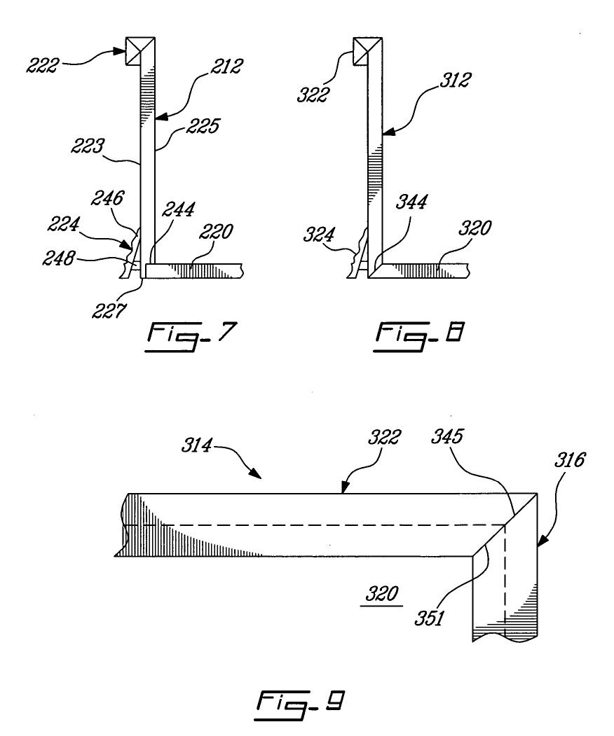

Turning now to FIG. 7, the side panel 212 is shown assembled to the bottom panel 220. The joint 244 between the side panel 212 and the bottom panel 220 consists here of an L shaped groove 244 defined into the lower edge 227 of the side panel 212, and in which the bottom panel 220 is fitted. In this side view, one also sees a molding 224 which is applied to the lowermost portion of the first side 223 of the side panel 212. In this embodiment, the molding 224 includes a facing 246 and a spacer 248. The facing 246 is relatively thin. In this case, it is made of wood and secured to the side panel 212 at its upper edge. The spacer 248 is disposed between the facing 246 and the side panel 212, at an intermediate height along the facing 246. The spacer 248 serves to maintain the intermediate height of the facing 246 solidly spaced from the side panel 212 to give the appearance that the molding is entirely of solid wood, but the costs are reduced since the inside of the molding is hollow. The spacer 248 can be made of any low-cost material suitable for its function, as is well known in the art. In FIG. 8, the mating edges of the side panel 312 and the bottom panel 220 are beveled, and are associated to form a beveled joint 344.

Turning now to FIG. 9, a beveled joint 345 defined between the right side panel 314 and the front panel 316 is depicted in better detail. It can be seen that the longitudinal dimension of the ledge 322 exceeds the longitudinal dimension of the remaining portion of the panel 314 due to this beveled joint 345 between the ledges. The beveled edges of the ledges abutting one another define a continuous peripheral ledge to the casket box 10 (see FIG. 1).

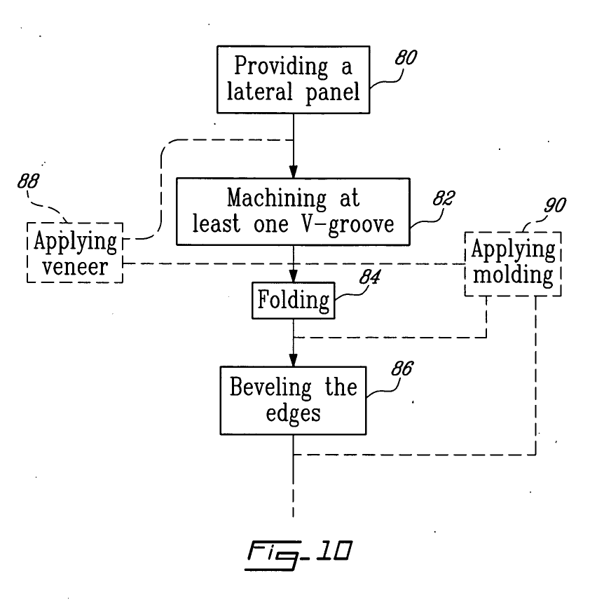

FIG. 10 summarizes the main steps in one embodiment of a method for making a lateral panels 12 (FIG. 1). A panel is provided 80. A first step 82 is machining V-grooves. A second step 84 is folding the ledge 22 into shape, along the V-grooves. In a third step 86, the lateral edges 51 of the folded panel are beveled into the beveled shape. The lower edge of the panel 12 can be machined into its joint shape at any time prior to assembly with the bottom panel 20. In one embodiment, the sheet of veneer is applied 88 to the panel 12 prior to folding 84. The optional molding 24 is applied 90 subsequently the step of machining 82: the spacer 248 is applied first, and the facing 246 is then applied onto the spacer 248 and panel 12. Once the casket box 10 is assembled, it is sent to a step of finishing (not shown).

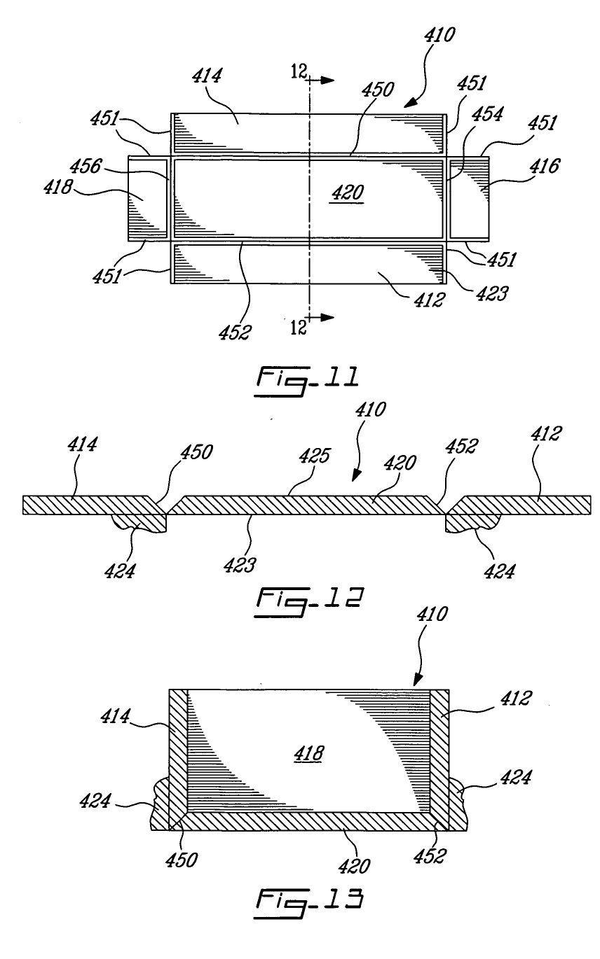

Turning now to FIG. 11, an other alternative embodiment of the improvements is depicted. Here, the panels 412, 414, 416, 418, and 420 are provided in the form of a blank 410. The blank 410 has an inner surface 423, and an outer surface 425 (see FIG. 12). The blank 410 includes the central bottom panel 420; two longitudinal side panels 412, 414, each joining an opposite longitudinal edge of the central bottom panel 420 by a respective V-groove 452, 450; a front panel 416 joining the central panel 420 by a V-groove 454; and a back panel 418 joining the central panel by a V-groove 416. The lateral sides 451 of the panels 412, 414, 416, 418 are beveled. The blank can therefore be folded into a box shape 410 as illustrated in FIG. 13 by folding the lateral panels 412, 414, 416 and 418 along their respective V-groove with respect to the blank, and the lateral edges 451 thereof are joined together after folding along their beveled shape. Moldings 424 can be applied to the lowermost portion of the lateral panel outer sides either prior to or subsequently to the step of folding.

The embodiments of the invention described above are intended to be exemplary only. For example, one skilled in the art will appreciate that the shape of the ledge 22 can differ from one of the above described embodiments. Moreover, the side panels can be adapted to be folded outwardly to form the ledge by other means than V-grooves, like slits performed on the first side of the blank allowing to fold the upper end thereof outwardly along a 180° angle. The ledge 22 can be adapted to be folded inwardly, instead of outwardly, to form an inward ledge (not shown), or can alternatively be defined at the bottom of the casket 10 instead of the upper end. Moreover, the ledge 22 does not necessarily completely surround the casket box 10. In view of the many possible alternatives, the scope of the invention is intended to be limited solely by the scope of the appended claims.

1. A casket box having a periphery of lateral panels connected to one bottom panel at a lower edge thereof, wherein: at least one of the lateral panels has a ledge towards a top thereof, the ledge being formed by a folded portion of the lateral panel being folded along at least one successive V-groove defined in the lateral panel.

2. The box of claim 1 wherein the periphery of lateral panels define an inside of the box and an outside of the box, the ledge extending laterally towards the outside of the box.

3. The box of claim 1 wherein the ledge is formed by successive folds of the lateral panel along two parallel and successive V-grooves defined in the lateral panel, the two V-grooves being immediately adjacent to one another and being parallel to an upper edge of the lateral panel, the upper edge being opposite to the lower edge.

4. The box of claim 1 wherein the ledge is formed by successive folds of the lateral panel along three parallel and successive V-grooves defined in the lateral panel, the three V-grooves being immediately adjacent to one another and to an upper edge of the lateral panel, the upper edge being opposite to the lower edge, whereby the upper edge of the lateral panel overlaps a portion of the unfolded portion.

5. The box of claim 1 wherein the faces of the lateral panel appearing on the outside of the box are veneered.

6. The box of claim 1 wherein the periphery is formed of four lateral panels, each lateral panel having a corresponding ledge.

7. The box of claim 6 wherein the mating edges of the lateral panels including the ledges are beveled, thus defining a continuous peripheral ledge.

8. The box of claim 1 wherein a molding is applied to a lowermost portion of the each one of the lateral portions, the moldings defining a continuous peripheral molding to the box.

9. The box of claim 4 wherein the unfolded portion is delimited from the folded portion by a fold line corresponding to the center of the one of the three successive V-grooves further away from the upper edge, the lateral panel also having a first side into which the V-groove is defined, and a second side opposite to the first side, the lateral panel further comprising a first sheet of veneer applied to an appearing portion on the first side of the unfolded portion, and a second sheet of veneer applied to the folded portion of the lateral panel, and on the second side thereof, the second sheet of veneer being folded on the ledge and covering the ledge.

10. The box of claim 9 wherein the portion of the unfolded section which is overlapped by the folded section is left bare of sheet of veneer.

11. The box of claim 5 wherein the sheet of veneer includes an outer layer and a hinge layer, the hinge layer facilitating the folding of the sheet of veneer along a 90° edge.

12. The box of claim 1 wherein the V groove defines an angle of 90° prior to folding.

13. A method of making a ledged lateral panel for a casket, the method comprising:
providing a panel having a first side, a second side, and four edges;
machining at least one V-groove parallel to a first edge of the panel; and
folding the panel along the at least one V-groove, into a ledge; and
beveling a second and third opposed edges of the panel including the ledge.

14. The method of claim 13 wherein the step of machining includes machining two parallel and adjacent V-grooves, and wherein the step of folding includes folding the panel successively along the two adjacent V-grooves.

15. The method of claim 13 wherein the step of machining includes machining three parallel and adjacent V-grooves, the three V-grooves being adjacent to the first edge of the panel, each V-groove having 90°, and wherein the step of folding includes folding successively along the three parallel V-grooves.

16. The method of claim 15 further comprising the step of applying a first sheet of veneer to a portion of the first side of the panel, said portion of the first side extending between a) the V-groove that is farthest away from the first edge, and b) the fourth edge; and applying a second sheet of veneer to a portion of the second side of the panel, said portion of the second side extending between a) the center of the V-groove being farthest away from the first edge, and b) the first edge.

17. The method of claim 13 further comprising the step of applying a molding to a portion of the first side nearest to the fourth edge.

18. A casket box including a bottom panel, two opposed side panels, a front panel and a back panel, the side panels being joined to a respective edge of the front and back panels by a beveled joint, the casket box being characterized in that the bottom, front, back, and side panels have a sheet of veneer on an outer side thereof, relative to the box, and are connected to the bottom panel along a respective folded V-grooves defined on the inside of the casket box, the sheet of veneer being folded outside the folded V-grooves, and the sheet of veneer includes an outer layer and an inner hinge layer to facilitate its folding.

19. A casket box as claimed in claim 18, wherein the outer layer is one of a paper sheet of veneer, a wood sheet of veneer, and a plastic sheet of veneer.

20. A casket box as claimed in claim 19 wherein the inner layer is one of a layer of kraft paper and a layer of cardboard.
